(19) United States
(12) Patent Application Publication
(10) Pub. No.: US 2021/0197131 A1
(43) Pub. Date: Jul. 1, 2021

(54) Filter Membrane Modifying Method Based On Metallic Oxide Particles

(71) Applicant: Harbin Institute of Technology, Harbin City, Heilongjiang Province (CN)

(72) Inventors: Jun MA, Harbin (CN); Lu WANG, Harbin (CN); Yulei LIU, Harbin (CN)

(21) Appl. No.: 17/058,257

(22) PCT Filed: Jul. 17, 2018
(86) PCT No.: PCT/CN2018/095976

§ 371 Date: Nov. 24, 2020

(30) Foreign Application Priority Data
May 25, 2018 (CN) 201810517233.7

(51) Int. Cl. B01D 67/00; C02F 1/28; B01D 71/34; B01D 71/04; B01D 71/02

(52) U.S. Cl. CPC B01D 67/0088; C02F 1/281; B01D 71/34; C02F 2101/20; B01D 71/024; C02F 1/285; C02F 1/288; B01D 71/04

(57) ABSTRACT

Provided is a filter membrane modifying method based on metallic oxide particles, relating to the field of membrane method water treatment. The method aims to resolve the problems existing in a common organic membrane or inorganic membrane that an intercepted substance is easily adsorbed on the surface of the membrane and in membrane holes during use so that the membrane holes are clogged, a membrane body is polluted, flux attenuation is quick, the service life of the membrane is shortened, and the backwashing efficiency is low. The method comprises: preparing a solution containing metallic oxide particles, then filtering, by using a filter membrane, the solution containing metallic oxide particles, and forming a metallic oxide particle cover layer on the surface of the filter membrane, i.e., completing the filter membrane modifying method based on metallic oxide particles.

### FIELD OF INVENTION

The present invention relates to a method of membrane water treatment.

### DESCRIPTION OF RELATED ARTS

Membrane separation technology has great potential in the field of water treatment. However, low membrane flux and serious membrane pollution are the main bottleneck problems restricting the development of the membrane technology. The current methods to improve membrane performance include membrane surface modification, pretreatment, physical and chemical cleaning methods and the like, wherein the membrane modification is the most fundamental method to improve membrane performance. At present, organic films (PVDF and the like) or inorganic films (ceramic films and the like) are commonly used and both exist problems in the process of use, which the retentate is easy to be adsorbed on the membrane surface and the membrane pores, causing the membrane pores to be blocked, the membrane body to be resistant to pollution and the flux to decay quickly, and the service life of the membrane is reduced. The theoretical value of the service life of the membrane is about 15 years, and the membrane pollution can reduce the service life to 8-10 years. The backwashing efficiency is low, and the backwashing interval of the membrane of the water treatment plant is about 1 hour.

More researches of iron manganese oxide particles in water treatment such as heavy metal adsorption and catalytic oxidation have been studied. They have good coagulation and flocculation effects whose particle sizes are small, and surface area is large. Iron manganese oxide particles have great potential for membrane surface modification to enhance the hydrophilicity of the membrane, increase the flux of the membrane, and improve the anti-pollution capability of the membrane.

### SUMMARY OF THE PRESENT INVENTION

### Technical Problems

In order to solve the common problems that existed in both the organic membrane or the inorganic membrane during the water treatment process, which the retentate is easy to be adsorbed on the membrane surface and the membrane pores, causing the membrane pores to be blocked, the membrane body to be resistant to pollution, the flux to decay quickly, the service life to be reduced and the low backwashing efficiency, the present invention provides a filter membrane modification method based on metal oxide particles.

### SOLUTIONS TO THE TECHNICAL PROBLEMS

### Technical Solutions

The filter membrane modification method based on metal oxide particles is carried out according to the following steps:

Prepare a solution containing metal oxide particles, and then use a filter membrane to filter the solution containing metal oxide particles to form a metal oxide particles covering layer with a thickness of 10 nm-1 mm on the surface of the filter membrane, then the filter membrane modification method based on metal oxide particles is completed.

The metal oxide particles in the solution contain iron oxide particles, manganese oxide particles, or a mixture of iron oxide particles and manganese oxide particles.

### ADVANTAGEOUS EFFECT OF THE PRESENT INVENTION

### Advantageous Effect

The present invention uses a specific method to produce metal oxide particles (iron oxide particles, manganese oxide particles or a mixture of iron oxide particles and manganese oxide particles), and then uses a filter membrane to filter the solution, and forms a metal oxide particles covering layer on the surface of the filter membrane by particle interception effect. The metal oxide particle covering layer has a good adsorption effect on heavy metal ions in the water body, and can intercept suspended substances in the water, partially adsorb dissolved organic substances in the water, and combine with microorganisms in the raw water. Since the physical bonding between the covering layer and the filter membrane is not tight, the covering layer can be easily removed through backwashing the filtered membrane, so microorganisms, biological membranes and intercepted suspended substances, dissolved organic matters and heavy metal ions which are attached to the covering layer are removed. Meanwhile, the microstructure of the metal oxide particle covering layer prepared by the present invention is loose metal oxide particles, which has good water permeability and will not significantly affect the water flux of the membrane component.

The main cause of membrane pollution in water treatment is that suspended matter, dissolved organic matter and microorganisms in the water adhere to the surface of the membrane, then microorganisms will use the organic matter to multiply on the surface of the filter membrane, and a biofilm will be formed, thus causing the water passages on the filter membrane surface to be blocked. As a result, the filter membrane needs to be backwashed and chemically washed regularly to remove suspended substances and biofilms on the surface to restore the membrane's water passage and water flux. At the same time, irreversible pollution of the membrane surface (pollutants that cannot be removed by backwashing and chemical washing activities) will cause a significant decrease in the service life of the membrane, and the water plant needs to replace the contaminated filter membrane regularly to ensure the stability of the overall water flux of the membrane component. The present invention can effectively reduce the attachment of suspended substances, dissolved organic matter and microorganisms on the surface of the filter membrane and blockage of the water passage of the filter membrane by means of physical isolation, thereby prolonging the backwash interval and the service life of the filter membrane. The membrane modification method of the present invention can greatly increase the removal ability of the filter membrane for heavy metal ions in the raw water, effectively intercept suspended solids and dissolved organic matter in the solution, significantly alleviate filter membrane pollution and extend the backwash interval for the filter membrane. The removal rate of the turbidity in the raw water reaches more than 95%, the removal rate of DOC reaches more than 80%, the removal rate of manganese ions in water reaches more than 70%, the removal rate of aluminum ions reaches more than 90%, and the time period of the backwash interval of the filter membrane is prolonged by 3-15 times. At the same time, the use of the membrane modification method can improve the degree of biological contamination of the filter membrane in the membrane bioreactor of the sewage treatment process, and prolong the backwash interval of the membrane component by 2 to 8 times. At the same time, the dosage of medicament (sodium hypochlorite or citric acid) required in the washing process of the membrane assembly can be reduced, and the dosage is reduced to 0.8 to 0.4 times of the original level.

The method of the present invention is to first prepare a solution containing metal oxide particles (iron oxide particles, manganese oxide particles or a mixture of iron oxide particles and manganese oxide particles) in nanometer to micrometer scale. The iron manganese oxide has good adsorption performance, flocculation performance and hydrophilicity. The filter membrane is used for filtering a solution containing iron manganese oxide, and a layer of covering layer can be formed on the surface of the filter membrane. The covering layer is an iron oxide particle layer, which has the characteristics of hydrophilicity, adsorption property, particle activity and the like, can be used for adsorbing pollutants in the raw water and prevent direct contact between the surface of the filter membrane and the microorganisms, thus producing the effect of preventing the formation of membrane pollution (biological pollution). At the same time, because the layer of iron oxide particles covers the surface of the membrane, it can be easily removed from the membrane surface by backwashing, and the method of the present invention can be used to re-attach to the membrane surface to achieve the effect of repeated protection, thus the filter membrane can be used for filtering repeatedly.

The principle of this membrane modification method is: First, hydrophilicity is the main reason that affect the anti-pollution performance of the membrane; the stronger the hydrophilicity, the lower the degree of irreversible pollution of the membrane. The metal oxide particles produced in situ have a strong surface hydroxylation degree, which is easy to form chemical or hydrogen bonds with water molecules and has strong hydrophilicity, This is beneficial to resist the formation of membrane pollution. Secondly, the iron-manganese oxide has good adsorption ability to heavy metal ions in water such as manganese, iron, cadmium, lead, arsenic and the like, and trace heavy metal pollutants in the raw water can be effectively intercepted. Thirdly, the structure of the metal oxide particle layer formed on the filter membrane surface by the method of the present invention is loose, which greatly increases the water-passing area, and this layer is an active layer, which can be easily removed from the filter membrane surface by backwashing and other means, thus significantly reducing the membrane pollution caused by attachment of microorganisms and organic matters. Lastly, the membrane modification method to which the method belongs is simple and easy to implement, and the filter membrane can be repeatedly protected by this method, which can delay the membrane pollution in a long term, reduce the dosage of the medicament required for washing of the membrane component, and improve the removal efficiency of the trace heavy metals in the raw water, and the reduce the operation cost of the membrane water treatment process.

The present invention is applied in a filter membrane modification method based on metal oxide particles.

### EMBODIMENTS OF THE PRESENT INVENTION

### Detailed Description of the Preferred Embodiment of the Present Invention

### Embodiment 1

The filter membrane modification method based on metal oxide particles according to this embodiment of the present invention is carried out according to the following steps:

Prepare a solution containing metal oxide particles, and then use a filter membrane to filter the solution containing metal oxide particles to form a covering layer of metal oxide particles with a thickness of 10 nm-1 mm on a surface of the filter membrane, then the filter membrane modification method based on metal oxide particles is completed.

The metal oxide particles in the solution contain iron oxide particles, manganese oxide particles, or a mixture of iron oxide particles and manganese oxide particles.

The beneficial effect of the present invention is: This embodiment of the present invention uses a specific method to produce metal oxide particles (iron oxide particles, manganese oxide particles or a mixture of iron oxide particles and manganese oxide particles), and then uses a filter membrane to filter the solution, and forms a covering layer of metal oxide particles on the surface of the filter membrane by particle interception effect. The metal oxide particle covering layer has a good adsorption effect on heavy metal ions in the water body, and can intercept suspended substances in the water, partially adsorb dissolved organic substances in the water, and combine with microorganisms in the raw water. Since the physical bonding between the covering layer and the filter membrane is not tight, the covering layer can be easily removed through backwashing the filter membrane, so microorganisms, biological membranes and intercepted suspended substances, dissolved organic matters and heavy metal ions which are attached to the covering layer are removed. Meanwhile, the microstructure of the metal oxide particle covering layer prepared by the present invention is loose metal oxide particles, which has good water permeability and will not significantly affect the water flux of the membrane component.

The main cause of membrane pollution in water treatment membranes is that suspended matter, dissolved organic matter and microorganisms in the water adhere to the surface of the membrane, then microorganisms will use the organic matter to multiply on the surface of the filter membrane, and a biofilm will be formed, thus causing the water passages on the filter membrane surface to be blocked. As a result, the filter membrane needs to be backwashed and chemically washed regularly to remove suspended substances and biofilms on the surface to restore the membrane's water passage and water flux. At the same time, irreversible pollution of the membrane surface (pollutants that cannot be removed by backwashing and chemical washing activities) will cause a significant decrease in the service life of the filter membrane, and the water plant needs to replace the contaminated filter membrane regularly to ensure the stability of the overall water flux of the membrane component. This embodiment of the present invention can effectively reduce the attachment of suspended substances, dissolved organic matter and microorganisms on the surface of the filter membrane and blockage of the water passage of the filter membrane by means of physical isolation, thereby prolonging the backwash interval and the service life of the filter membrane. The membrane modification method of this embodiment of the present invention can greatly increase the removal ability of the filter membrane for heavy metal ions in the raw water, effectively intercept suspended solids and dissolved organic matter in the solution, significantly alleviate filter membrane pollution and extend the backwash interval for the filter membrane. The removal rate of the turbidity in the raw water reaches more than 95%, the removal rate of DOC reaches more than 80%, the removal rate of manganese ions in water reaches more than 70%, the removal rate of aluminum ions reaches more than 90%, and the time period of the backwash interval of the filter membrane is prolonged by 3-15 times. At the same time, the use of the membrane modification method can improve the degree of biological contamination of the filter membrane in the membrane bioreactor of the sewage treatment process, and prolong the backwashing interval of the membrane component by 2 to 8 times. At the same time, the dosage of medicament (sodium hypochlorite or citric acid) required in the washing process of the membrane component can be reduced, and the dosage is reduced to 0.8 to 0.4 times of the original level.

The method of this embodiment of the present invention is to first prepare a solution containing metal oxide particles (iron oxide particles, manganese oxide particles or a mixture of iron oxide particles and manganese oxide particles) in nanometer to micrometer scale. The iron manganese oxide has good adsorption performance, flocculation performance and hydrophilicity. The filter membrane is used for filtering a solution containing iron manganese oxide, and a layer of covering layer can be formed on the surface of the filter membrane. The covering layer is an iron oxide particle layer having the characteristics of hydrophilicity, adsorption property, particle activity and the like, which can be used for adsorbing pollutants in the raw water and prevent direct contact between the surface of the filter membrane and the microorganisms, thus producing the effect of preventing the formation of membrane pollution (biological pollution). At the same time, because the layer of iron oxide particles covers the surface of the membrane, it can be easily removed from the membrane surface by backwashing, and the method of this embodiment of the present invention can be used to re-attach the layer of iron oxide particles to the membrane surface to achieve the effect of repeated protection, thus the filter membrane can be used for filtering repeatedly.

The principle of this membrane modification method is: First, hydrophilicity is the main reason that affect the anti-pollution performance of the membrane; the stronger the hydrophilicity, the lower the degree of irreversible pollution of the membrane. The metal oxide particles produced in situ have a strong surface hydroxylation degree, which is easy to form chemical or hydrogen bonds with water molecules and has strong hydrophilicity, which is beneficial to resist the formation of membrane pollution. Secondly, the iron/manganese oxide has good adsorption ability to heavy metal ions in water such as manganese, iron, cadmium, lead, arsenic and the like, and trace heavy metal pollutants in the raw water can be effectively intercepted. Thirdly, the structure of the metal oxide particle layer formed on the filter membrane surface by the method of the present invention is loose, which greatly increases the water-passing area, and this layer is an active layer, which can be easily removed from the filter membrane surface by backwashing and other means, thus significantly reducing the membrane pollution caused by attachment of microorganisms and organic matters. Lastly, the membrane modification method to which the method belongs is simple and easy to implement, and the filter membrane can be repeatedly protected by this method, which can delay the membrane pollution in a long term, reduce the dosage of the medicament required for washing of the membrane component, and improve the removal efficiency of the trace heavy metals in the raw water, and the reduce the operation cost of the membrane water treatment process.

This embodiment uses a filter membrane, which is prepared by a filter membrane modification method based on metal oxide particles, for water treatment; the water body is the surface water of a water supply source, ground water, sewage or sea water that needs advanced treatment; the pH of the water body is 6.0-8.0, and the filter membrane prepared by the filter membrane modification method based on metal oxide particles according to this embodiment is used in a membrane bioreactor.

### Embodiment 2

The difference between this embodiment and the embodiment 1 is that: the solution containing metal oxide particles is prepared by reacting of ferrate or permanganate with an aqueous solution containing reducing substances. Others are the same as the embodiment 1.

### Embodiment 3

The difference between this embodiment and the embodiment 1 or 2 is that: in the aqueous solution containing reducing substances, the reducing substances are Fe²⁺ or Mn²⁺. Others are the same as the embodiment 1 or 2.

### Embodiment 4

The difference between this embodiment and one of the embodiments 1-3 is that: the solution containing metal oxide particles is prepared by reacting of oxidant with an aqueous solution containing reducing substances; the reducing substances in the aqueous solution are Fe²⁺ or Mn²⁺ or a mixture of Fe' and Mn²⁺. Others are the same as the embodiments 1-3.

### Embodiment 5

The difference between this embodiment and one of the embodiments 1-4 is that: the oxidant is ozone, monopersulfate, peroxodisulfate, hydrogen peroxide or hypochlorite. Others are the same as the embodiments 1-4.

### Embodiment 6

The difference between this embodiment and one of the embodiments 1-5 is that: the filter membrane is an organic membrane or an inorganic membrane. Others are the same as the embodiments 1-5.

### Embodiment 7

The difference between this embodiment and one of the embodiments 1-6 is that: the organic membrane is PVDF membrane, PVC membrane, PES membrane, PS membrane, PP membrane, PE membrane, PAN membrane, aromatic polyamide membrane or cellulose acetate membrane. Others are the same as the embodiments 1-6.

### Embodiment 8

The difference between this embodiment and one of the embodiments 1-7 is that: the inorganic membrane is ceramic membrane or glass fiber membrane. Others are the same as the embodiments 1-7.

### Embodiment 9

The difference between this embodiment and one of the embodiments 1-8 is that: a concentration of the solution containing metal oxide particles is 0.1g/L to 500g/L. Others are the same as the embodiments 1-8.

### Embodiment 10

The difference between this embodiment and one of the embodiments 1-9 is that: a covering layer of metal oxide particles with a thickness of 100 nm-5 μm is formed on the surface of the filter membrane. Others are the same as the embodiments 1-9.

The advantageous effect of the present invention is verified by the exemplary embodiments as follows:

### Exemplary Embodiment 1

A filter membrane modification method based on metal oxide particles is carried out according to the following steps:

Prepare a solution containing metal oxide particles, and then use a filter membrane to filter 500 mL of the solution containing metal oxide particles to form a covering layer of metal oxide particles with a thickness of 500 nm on a surface of the filter membrane, then the filter membrane modification method based on metal oxide particles is completed;

the metal oxide particles in the solution containing metal oxide particles are iron oxide particles;

the solution containing metal-containing oxide particles is prepared by reacting of potassium ferrate solution with a concentration of 50 g/L and aqueous solution containing ferrous chloride with a concentration of 30 g/L for 5 minutes;

the filter membrane is a PVDF membrane;

the concentration of the solution containing metal-containing oxide particles is 50 g/L;

the filter membrane prepared by the filter membrane modification method based on metal oxide particles in this embodiment is used to treat surface water with a with a dissolved organic content of 6 mgC/L and a turbidity of 10 NTU;

the pH of the surface water is 6.8.

According to this embodiment, the removal rate of DOC in the water body reaches 90%, the removal rate of turbidity reaches 95%, the flux is increased by 2.5 times, and the backwashing interval is prolonged from the original 1 hour per flush to 5 hours per flush.

### Exemplary Embodiment 2

A filter membrane modification method based on metal oxide particles is carried out according to the following steps:

Prepare a solution containing metal oxide particles, and then use a filter membrane to filter 1 L of the solution containing metal oxide particles to form a covering layer of metal oxide particles with a thickness of 1000 nm on a surface of the filter membrane, then the filter membrane modification method based on metal oxide particles is completed;

the metal oxide particles in the solution containing metal oxide particles are mixture of iron oxide particles and manganese oxide particles;

the solution containing metal-containing oxide particles is prepared by mixing potassium ferrate solution with a concentration of 80 g/L and aqueous solution containing manganese chloride with a concentration of 160 g/L, and reacting for 5 minutes under a stirring condition at 200 rpm.

The filter membrane is a PVDF hollow fiber membrane.

The concentration of the solution containing metal-containing oxide particles is 200 g/L.

The filter membrane prepared by the filter membrane modification method based on metal oxide particles in this embodiment is used to treat surface water with a with a dissolved organic content of 5 mgC/L and a turbidity of 7 NTU;

the pH of the surface water is 7.2.

According to this embodiment, the removal rate of DOC in the water body reaches 92%, the removal rate of turbidity reaches 96%, the flux is increased by 4 times, and the backwashing interval is prolonged from the original 1 hour per flush to 8 hours per flush.

### Exemplary Embodiment 3

A filter membrane modification method based on metal oxide particles is carried out according to the following steps:

Prepare a solution containing metal oxide particles, and then use a filter membrane to filter 500 mL of the solution containing metal oxide particles to form a covering layer of metal oxide particles with a thickness of 100 nm on a surface of the filter membrane, then the filter membrane modification method based on metal oxide particles is completed;

the metal oxide particles in the solution containing metal oxide particles are iron oxide particles;

the solution containing metal-containing oxide particles is prepared by reacting of potassium ferrate solution with a concentration of 10 g/L and aqueous solution containing ferrous chloride with a concentration of 10 g/L for 5 minutes;

the filter membrane is a ceramic membrane;

the concentration of the solution containing metal-containing oxide particles is 14 g/L.

The filter membrane prepared by the filter membrane modification method based on metal oxide particles in this embodiment is used to treat surface water with a dissolved organic content of 8 mgC/L and a turbidity of 10 NTU;

the pH of the surface water is 6.5.

According to this embodiment, the removal rate of DOC in the water body reaches 94%, the removal rate of turbidity reaches 95%, the flux is increased by 4 times, and the backwash interval is prolonged from the original 1 hour per flush to 6 hours per flush.

### Exemplary Embodiment 4

A filter membrane modification method based on metal oxide particles is carried out according to the following steps:

Prepare a solution containing metal oxide particles, and then use a filter membrane to filter 1 L of the solution containing metal oxide particles to form a covering layer of metal oxide particles with a thickness of 0.1 mm on a surface of the filter membrane, then the filter membrane modification method based on metal oxide particles is completed;

the metal oxide particles in the solution containing metal oxide particles are mixture of iron oxide particles and manganese oxide particles;

the solution containing metal-containing oxide particles is prepared by mixing potassium ferrate solution with a concentration of 10 g/L and aqueous solution containing manganese chloride with a concentration of 5 g/L, and reacting for 5 minutes under a stirring condition at 200 rpm.

The filter membrane is a ceramic membrane.

The concentration of the solution containing metal oxide particles is 10 g/L.

The filter membrane prepared by the filter membrane modification method based on metal oxide particles in this embodiment is used to treat seawater with a dissolved organic content of 10 mgC/L and a turbidity of 10 NTU;

the pH of the seawater is 6.9.

According to this embodiment, the removal rate of DOC in the water body reaches 90%, the removal rate of turbidity reaches 95%, the flux is increased by 2 times, and the backwash interval is prolonged from the original 1 hour per flush to 8 hours per flush.

### Exemplary Embodiment 5

A filter membrane modification method based on metal oxide particles is carried out according to the following steps:

Prepare a solution containing metal oxide particles, and then use a filter membrane to filter 500 mL of the solution containing metal oxide particles to form a covering layer of metal oxide particles with a thickness of 0.15 mm on a surface of the filter membrane, then the filter membrane modification method based on metal oxide particles is completed;

the metal oxide particles in the solution containing metal oxide particles are iron oxide particles;

the solution containing metal oxide particles is prepared by reacting of an aqueous solution containing ferrous chloride with ozone for 5 minutes; during the reaction, the concentration of ozone in the solution is 30 g/L, and the concentration of ferrous chloride is 10 g/L.

The filter membrane is a ceramic membrane;

the concentration of the solution containing metal oxide particles is 10 g/L.

The filter membrane prepared by the filter membrane modification method based on metal oxide particles in this embodiment is used to treat sewage with a dissolved organic content of 15 mgC/L and a turbidity of 20 NTU;

the pH of the sewage is 7.4.

According to this embodiment, the removal rate of DOC in the water body reaches 90%, the removal rate of turbidity reaches 95%, the flux is increased by 3.5 times, and the backwash interval is prolonged from the original 0.8 hour per flush to 8 hours per flush.

### Exemplary Embodiment 6

A filter membrane modification method based on metal oxide particles is carried out according to the following steps:

Prepare a solution containing metal oxide particles, and then use a filter membrane to filter 4 L of the solution containing metal oxide particles to form a covering layer of metal oxide particles with a thickness of 0.08 mm on a surface of the filter membrane, then the filter membrane modification method based on metal oxide particles is completed;

the metal oxide particles in the solution containing metal oxide particles are mixture of iron oxide particles and manganese oxide particles;

the solution containing metal oxide particles is produced by reacting of an aqueous solution containing a reducing substance with ozone for 40 minutes; the reducing substance is a mixture of ferrous chloride and manganese chloride; during the reaction, the concentration of ozone in the solution is 60 g/L, the concentration of ferrous chloride is 35 g/L, and the concentration of manganese chloride is 15 g/L;

the filter membrane is a PVDF hollow fiber membrane;

the concentration of the solution containing metal oxide particles is 35 g/L.

The filter membrane prepared by the filter membrane modification method based on metal oxide particles in this embodiment is used in a membrane bioreactor to treat domestic sewage with a COD content of 80 mg/L, and the pH of the domestic sewage is 6.9.

According to this embodiment, while the effluent quality meets China's ‘Urban Sewage Treatment Plant Pollutant Discharge Standard’ (GB 18918-2002), the backwashing interval of the membrane component can be extended to three times of the original time, the dosage of cleaning agent (sodium hypochlorite) required for washing the membrane component is reduced to half of the original dosage, and the service life of the membrane is extended to 1.3 times of the original level.

What is claimed is:

1. A filter membrane modification method based on metal oxide particles, characterized in that, the filter membrane modification method based on metal oxide particles is carried out according to the following steps:
Preparing a solution containing metal oxide particles, and then using a filter membrane to filter the solution containing metal oxide particles to form a covering layer of metal oxide particles with a thickness of 10 nm-1 mm on a surface of the filter membrane, then the filter membrane modification method based on metal oxide particles is completed;
the metal oxide particles in the solution are iron oxide particles, manganese oxide particles, or a mixture of iron oxide particles and manganese oxide particles.

2. The filter membrane modification method based on metal oxide particles according to claim 1, characterized in that: the solution containing metal oxide particles is produced by reacting of ferrate or permanganate with an aqueous solution containing reducing substances.

3. The filter membrane modification method based on metal oxide particles according to claim 2, characterized in that: in the aqueous solution containing reducing substances, the reducing substances are Fe²⁺ or Mn²⁺.

4. The filter membrane modification method based on metal oxide particles according to claim 1, characterized in that: the solution containing metal oxide particles is produced by reacting of oxidant with an aqueous solution containing reducing substances; the reducing substances in the aqueous solution are Fe²⁺ or Mn²⁺ or a mixture of Fe²⁺ and Mn²⁺.

5. The filter membrane modification method based on metal oxide particles according to claim 4, characterized in that: the oxidant is ozone, monopersulfate, peroxodisulfate, hydrogen peroxide or hypochlorite.

6. The filter membrane modification method based on metal oxide particles according to claim 1, characterized in that: the filter membrane is an organic membrane or an inorganic membrane.

7. The filter membrane modification method based on metal oxide particles according to claim 6, characterized in that: the organic membrane is PVDF membrane, PVC membrane, PES membrane, PS membrane, PP membrane, PE membrane, PAN membrane, aromatic polyamide membrane or cellulose acetate membrane.

8. The filter membrane modification method based on metal oxide particles according to claim 6, characterized in that: the inorganic membrane is ceramic membrane or glass fiber membrane.

9. The filter membrane modification method based on metal oxide particles according to claim 1, characterized in that: a concentration of the solution containing metal oxide particles is 0.1 g/L to 500 g/L.

10. The filter membrane modification method based on metal oxide particles according to claim 1, characterized in that: a covering layer of metal oxide particles with a thickness of 100 nm-5 μm is formed on the surface of the filter membrane.
